(19) United States
(12) Patent Application Publication
(10) Pub. No.: US 2013/0346584 A1
(43) Pub. Date: Dec. 26, 2013

(54) CONTROL METHOD FOR VIRTUAL COMPUTER, AND VIRTUAL COMPUTER SYSTEM

(71) Applicants: Takashi Tameshige, Tokyo (JP); Yujiro Ichikawa, Tokyo (JP)

(72) Inventors: Takashi Tameshige, Tokyo (JP); Yujiro Ichikawa, Tokyo (JP)

(73) Assignee: HITACHI, LTD., Tokyo (JP)

(21) Appl. No.: 14/003,370

(22) PCT Filed: Jun. 2, 2011
(86) PCT No.: PCT/JP2011/062680

§ 371 Date: Sep. 5, 2013

(51) Int. Cl. H04L 12/24

(52) U.S. Cl. CPC H04L 41/00
USPC 709/223

(57) ABSTRACT

A control method for a virtual computer comprising a plurality of physical computers, a management server for managing the plurality of physical computers, and at least one virtual computer, which is provided by a virtualizing part executed on each of the plurality of physical computers, the management server controlling the at least one virtual computer and the virtualization part, the control method comprising: detecting, by the management server, a relationship between the virtualization part and the virtual computer operating on the plurality of physical computers; detecting, by the management server, an operation state of the virtual computer; and one of restraining and permitting, by the management server, when the management server issues a command for changing a state to one of the virtualization part and the virtual computer, issuance of the command based on an operation state of the virtual computer in a coupling relationship with the virtualization part.

### BACKGROUND

This invention relates to a method for avoiding an interruption of a business task caused by an operation error of a user on a virtualization part on a lower layer of a virtual server on which the business task is running in a computer system employing the server virtualization technology. Further, when the virtualization is carried out on a plurality of stages, the method further determines whether or not an operation is available on a layer equal to or lower than the virtual server on which the virtualization part is running, thereby avoiding an interruption of a business task.

In recent years, as a result of an expansion of a virtual server market, servers on which business tasks are running can be consolidated into a virtual server. The consolidation of the servers can reduce physical computer resources, resulting in a reduction in cost. On the other hand, the physical computer resources are shared on the virtual servers, and hence when a power supply to the physical computer is shutdown though a virtual computer is running on the physical server, this change in state can cause a problem of loss of the virtual computer.

Further, there is also known a multi-stage virtual computer system where virtualization parts are configured on a plurality of stages, thereby efficiently using physical computer resources. In the multi-stage virtual computer system, a virtualization part on a lower layer (hereinafter referred to as first virtualization part) runs on the physical computer, a plurality of virtualization parts on an upper layer (on an application side) (hereinafter referred to as second virtualization parts) run on the first virtualization part, and a plurality of virtual computers are provided on the second virtualization parts. In the configuration in which the virtual computers are running on the multi-stage virtual computer system, when a function such as live migration specific to the virtual computer is carried out simultaneously on the upper layer and the lower layer (hardware side), an unexpected decrease in performance or an unexpected system stop can occur. As a technology for preventing this type of failure, for example, Japanese Patent No. 4605072 is known. According to Japanese Patent No. 4605072, while a certain policy instance is executed, when an application condition of another policy instance is satisfied, corresponding component lists are compared with each other, and if there is no overlap, the another policy instance is executed, and if there is an overlap, the execution of the another policy instance is suspended.

### SUMMARY

However, the above-mentioned technology does not taken into account, for example, the upper layer and the lower layer in the multi-stage virtual computer environment in which the virtualization is carried out on a plurality of stages. In other words, there is such a problem that when the first virtualization part running as the lower layer on the physical computer receives a command to change the state, and the second virtualization part running on the first virtualization part receives a predetermined command, the first virtualization part and the second virtualization part simultaneously carry out the commands, and a virtual computer does not operate normally, which causes a stop of a business task. For example, when the state change command received by the first virtualization part is a command for stopping and the command received by the second virtualization part is a command for migration of the virtual computer, if these commands are simultaneously executed, the first virtualization part stops before the second virtualization part completes the migration of the virtual computer, and hence the second virtualization part running on the first virtualization part needs to stop, and the migration of the virtual computer will not be completed. As a result, the virtual computer on the second virtualization part stops. In this way, there is a problem in that if an administrator operating a management computer of the multi-stage virtual computer system issues wrong commands to the virtualization part on the upper layer and the virtualization part on the lower layer, an unexpected stop of the virtual computer and the like occur.

It is an object of this invention to avoid a stop of a business task caused by an operation error by an administrator or the like in a multi-stage virtual computer system.

A representative aspect of this invention is as follows. A control method for a virtual computer comprising a plurality of physical computers each comprising a processor and a memory, a network for coupling the plurality of physical computers to each other, a management server for managing the plurality of physical computers, and at least one virtual computer, which is provided by a virtualizing part executed on each of the plurality of physical computers, the management server controlling the at least one virtual computer and the virtualization part, the control method comprising: a first step of detecting, by the management server, a relationship between the virtualization part and the virtual computer operating on the plurality of physical computers; a second step of detecting, by the management server, an operation state of the virtual computer; and a third step of one of restraining and permitting, by the management server, when the management server issues a command for changing a state to one of the virtualization part and the virtual computer, issuance of the command based on an operation state of the virtual computer in a coupling relationship with the virtualization part.

According to this invention, the stop of the business task caused by an operation error by the administrator or the like can be avoided in the multi-stage virtual computer system.

### BRIEF DESCRIPTION OF THE DRAWINGS

FIG. 1 is a block diagram illustrating an example of a configuration of a multi-stage virtual computer system according to an embodiment of this invention.

FIG. 2 is a block diagram illustrating a configuration of the management server according to the embodiment of this invention.

FIG. 3 is a block diagram illustrating a configuration of providing the virtual servers on the physical server according to the embodiment of this invention.

FIG. 4 is a block diagram illustrating another configuration example of the physical server according to the embodiment of this invention.

FIG. 5 is a block diagram schematically illustrating this invention.

FIG. 6A shows an example of the physical server management table of the first half according to the embodiment of this invention.

FIG. 6B shows an example of the physical server management table of the second half according to the embodiment of this invention.

FIG. 7 illustrates the virtualization part management table according to the embodiment of this invention.

FIG. 8A illustrates the virtual server management table of the first half according to the embodiment of this invention.

FIG. 8B illustrates the virtual server management table of the second half according to the embodiment of this invention.

FIG. 9 illustrates the OS management table according to the embodiment of this invention.

FIG. 10 illustrates the business task management table according to the embodiment of this invention.

FIG. 11A shows the system management table of the first half according to the embodiment of this invention.

FIG. 11B shows the system management table of the second half according to the embodiment of this invention.

FIG. 12 shows the command management table according to the embodiment of this invention.

FIG. 13 shows a configuration availability management table according to the embodiment of this invention.

FIG. 14 is a flowchart illustrating an example of processing carried out by the control part of the management server according to the embodiment of this invention.

FIG. 15 is a flowchart illustrating an example of processing carried out by the influence extent detection part according to the embodiment of this invention.

FIG. 16 is a flowchart illustrating an example of processing carried out by the configuration availability determination part according to the embodiment of this invention.

FIG. 17 is a flowchart illustrating an example of processing carried out by the management subject configuration part according to the embodiment of this invention.

FIG. 18 is a flowchart illustrating an example of processing carried out by the table configuration part according to the embodiment of this invention.

### DETAILED DESCRIPTION OF THE PREFERRED EMBODIMENT

An embodiment of this invention is described below with reference to the accompanying drawings.

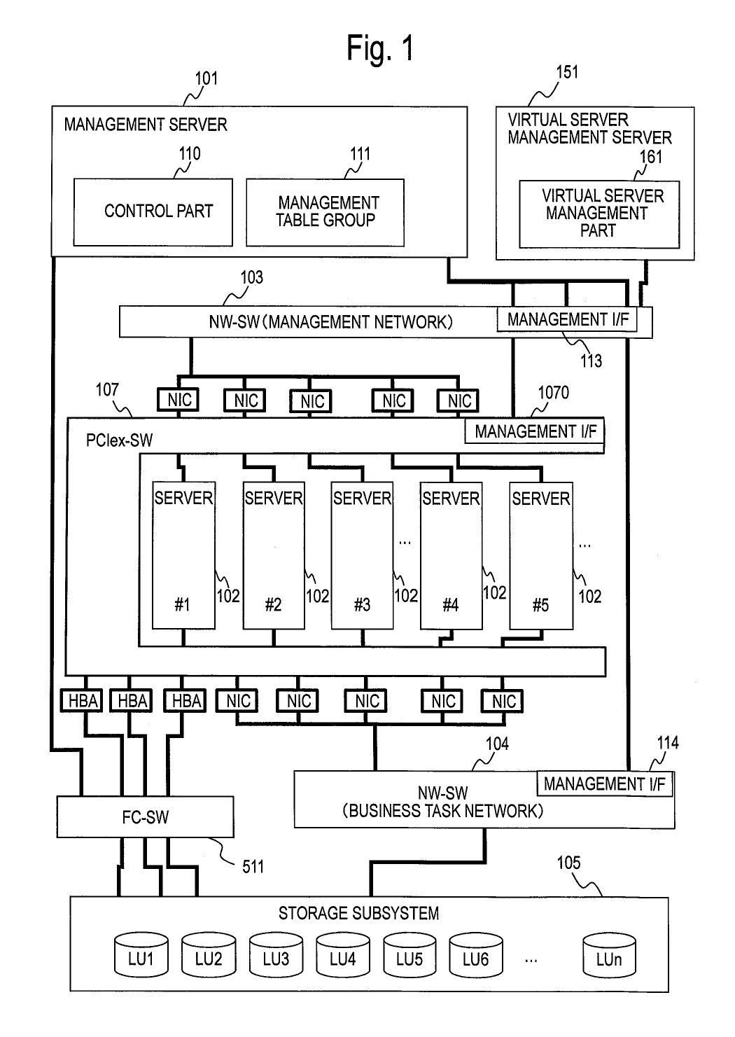

FIG. 1 is a block diagram illustrating an example of a configuration of a multi-stage virtual computer system according to the embodiment of this invention.

The management server 101 is coupled via a network switch for management (NW-SW) 103 to a management interface (management I/F) 113 of the NW-SW 103, and to a management interface 114 of a network switch for business task (NW-SW) 104, and a virtual LAN (VLAN) of each of the NW-SWs 103 and 104 can be configured from the management server 101. Moreover, to the network switch for management 103, in addition to the management server 101 and servers 102, a virtual server management server 151 for managing virtual servers (virtual machines) provided on the physical servers 102 is coupled.

The NW-SW 103 constructs a network for management, which is a network for the management server 101 to manage operations such as distribution of an OS and applications running on the plurality of physical servers 102 and power supply control. The NW-SW 104 constructs a network for business task, which is a network used by business task applications executed on virtual servers 404 on the servers 102. The NW-SW 104 is coupled to a WAN or the like for communicating to/from client computers outside the virtual computer system.

The management server 101 is coupled via a fiber channel switch (FC-SW) 511 to a storage subsystem 105. The management server 101 manages N logical unit (LU)1 to LUn in the storage subsystem 105.

On the management server 101, a control part 110 for managing the servers 102 is running, and refers to and updates a management table group 111. The management table group 111 is updated by the control part 110 at a predetermined cycle.

The servers 102 subject to the management by the management server 101 provide virtual servers as described later. The servers 102 are coupled via a PCIex-SW 107 and I/O devices (in FIG. 1, NICs and HBAs) to the NW-SWs 103 and 104. To the PCIex-SW 107, the I/O devices (I/O adaptors such as network interface cards (NICs), host bus adapters (HBAs), and converged network adapters (CNAs)) compliant with the PCI Express standard are coupled. In general, the PCIex-SW 107 is an I/O switch for extending a bus of the PCI Express out from a mother board (or server blade) to couple more PCI-EXpress devices. It should be noted such a system configuration that the servers 102 are directly coupled to the NW-SWs 103 and 104 without the intermediation of the PCIex-SW 107 is conceivable.

Moreover, the management server 101 is coupled to a management interface 1070 of the PCIex-SW 107 to manage coupling relationships between the plurality of servers 102 and the I/O devices. Moreover, the server 102 makes access via the I/O devices (in FIG. 1, HBAs) coupled to the PCIex-SW 107 to the LU1 to LUn of the storage subsystem 105.

The virtual server management server 151 manages a virtualization part 401 and the virtual servers 404 executed on each of the servers 102, and a virtual server management part 161 issues a command to the virtualization part 401. Specifically, the virtual server management server 151 instructs power supply control for the virtual servers 404 and migration of the virtual servers 404 and the virtualization part 401. It should be noted that the management server 101 may include the virtualization server management part 161.

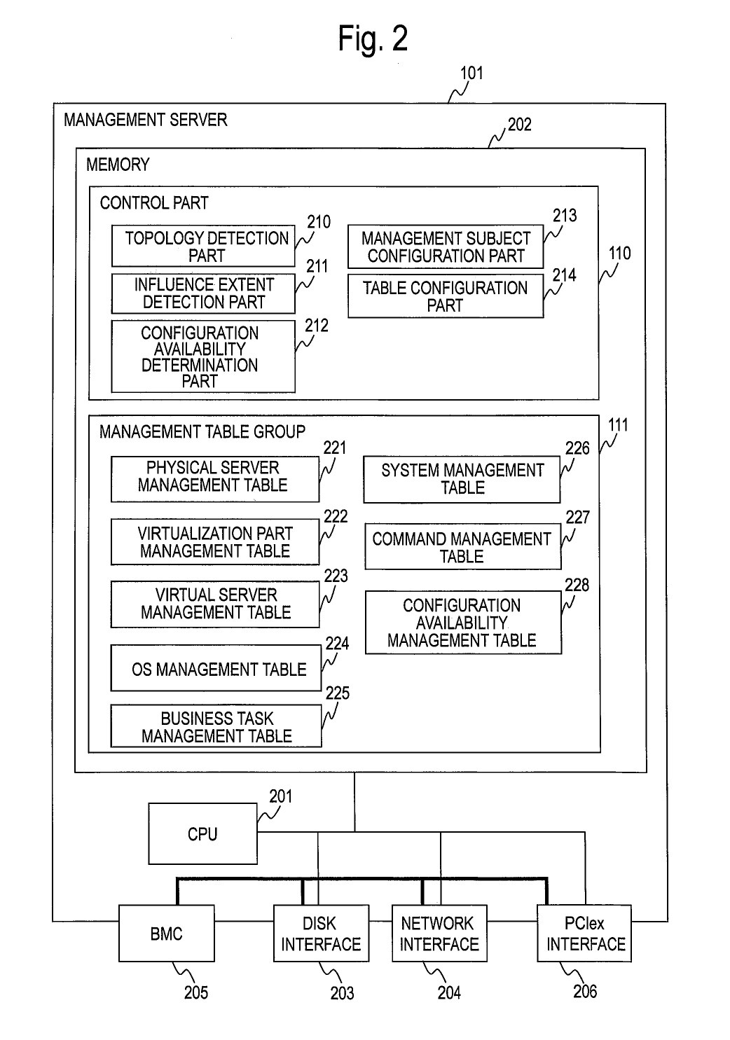

FIG. 2 is a block diagram illustrating a configuration of the management server 101. The management server 101 includes a central processing unit (CPU) 201 for processing calculation, a memory 202 for storing programs executed by the CPU 201, and data required for the execution of the programs, a disk interface 203 for making access to the storage subsystem 105 for storing the programs and the data, a network interface 204 for communication via an IP network, a basement management controller (BMC) 205 for carrying out the power supply control, and controlling the respective interfaces, and a PCI-Express interface 206 for coupling to the PCIex-SW 107.

In the management server 101 of FIG. 2, representative one is illustrated for each of the network interface 204, the disk interface 203, and the PCIex interface 206, but there may be such a configuration that a plurality thereof exist. For example, for the respective couplings to the management network 103 and the business task network 104, network interfaces 204 different from each other are used.

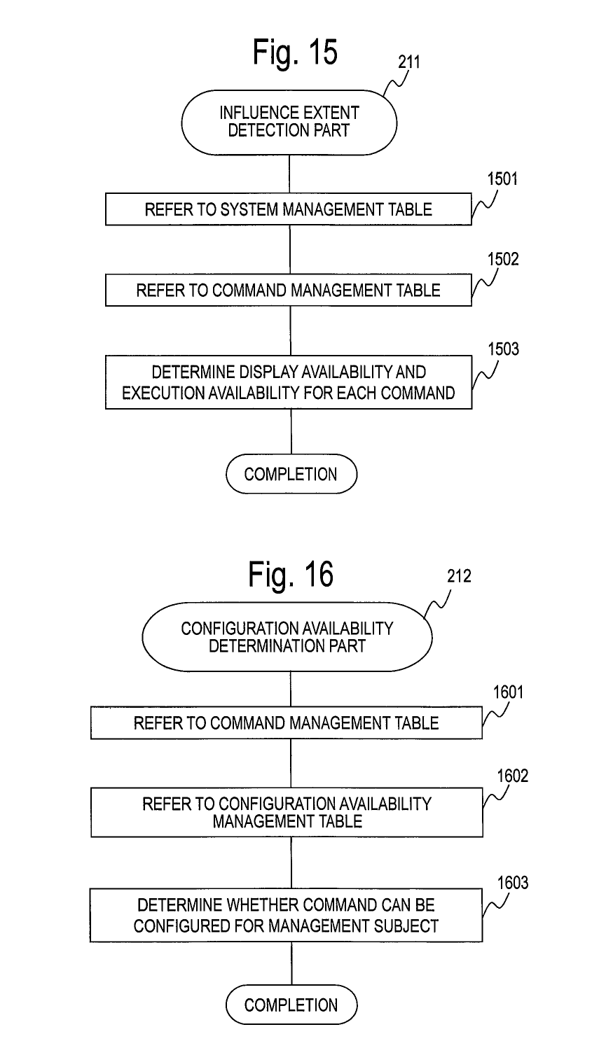

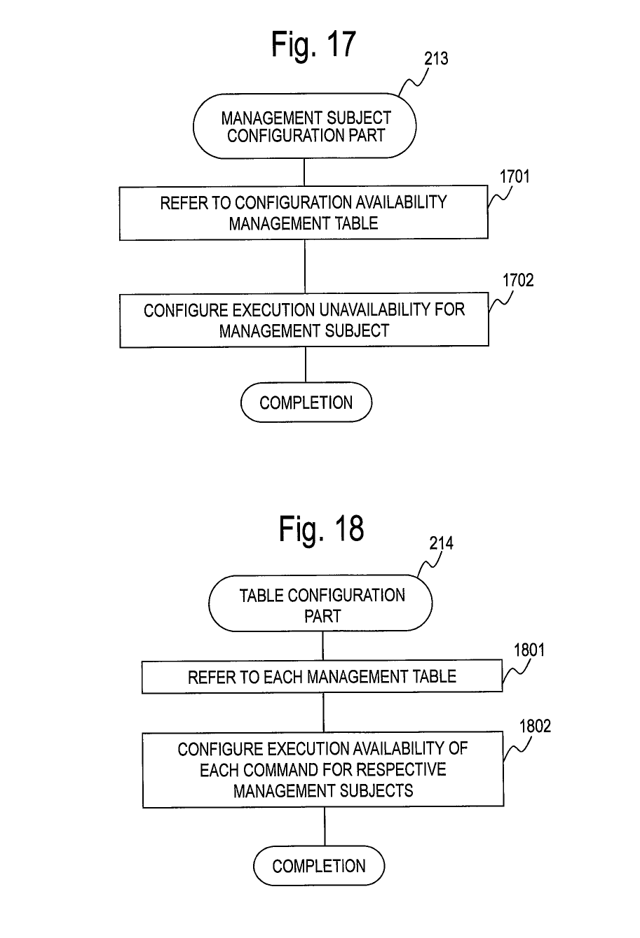

In the memory 202, the control part 110 and the management table group 111 are stored. The control part 110 includes a topology detection part 210, an influence extent detection part 211 (refer to FIG. 15), a configuration availability determination part 212 (refer to FIG. 16), a management subject configuration part 213 (refer to FIG. 17), and a table configuration part 214 (refer to FIG. 18).

The respective functional parts, which are the topology detection part 210, the influence extent detection part 211, the configuration availability determination part 212, the management subject configuration part 213, and the table configuration part 214 are loaded as programs onto the memory 202.

The CPU 201 operates depending on a program of each of the functional parts, thereby operating as the functional part for realizing a predetermined function. For example, the processor operates depending on an influence extent detection program to function as the influence extent detection part 211. The same holds true for the other programs. Further, the CPU 201 also operates as functional parts for realizing a plurality of respective pieces of processing carried out by the respective programs. The computer and the computer system are an apparatus and a system including those functional parts.

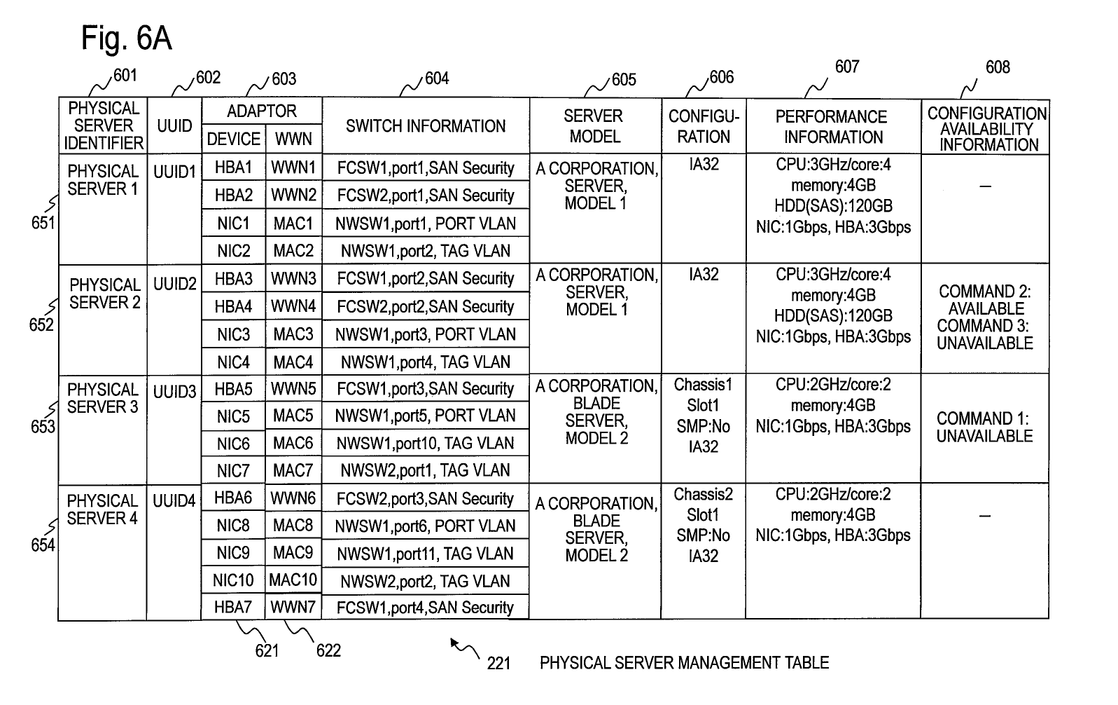

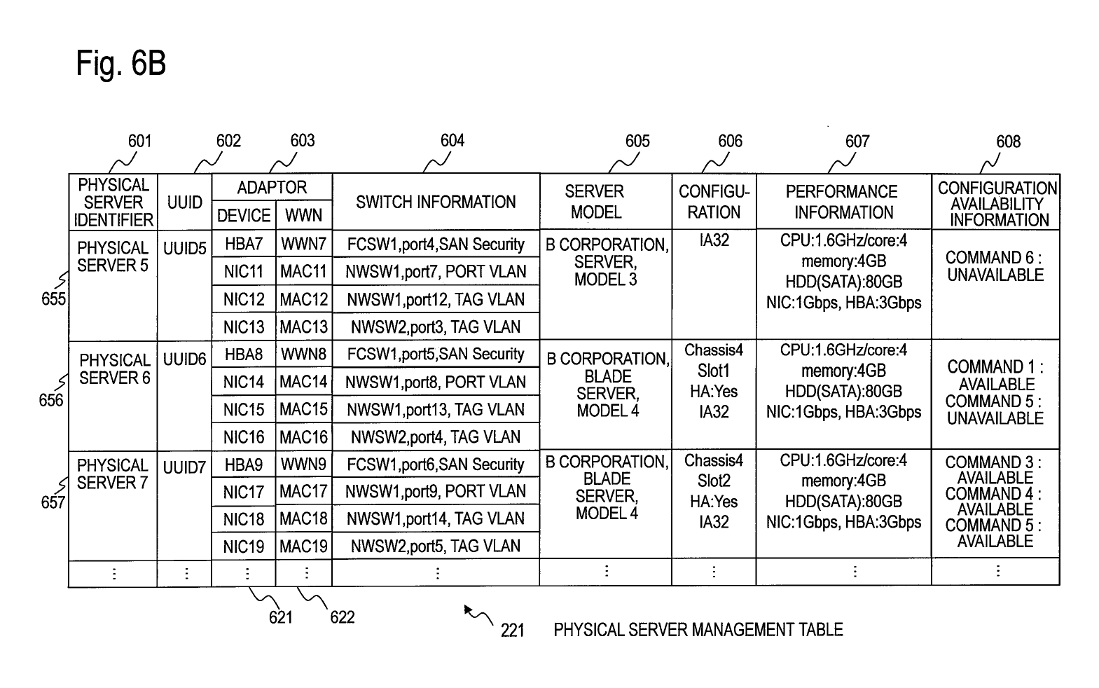

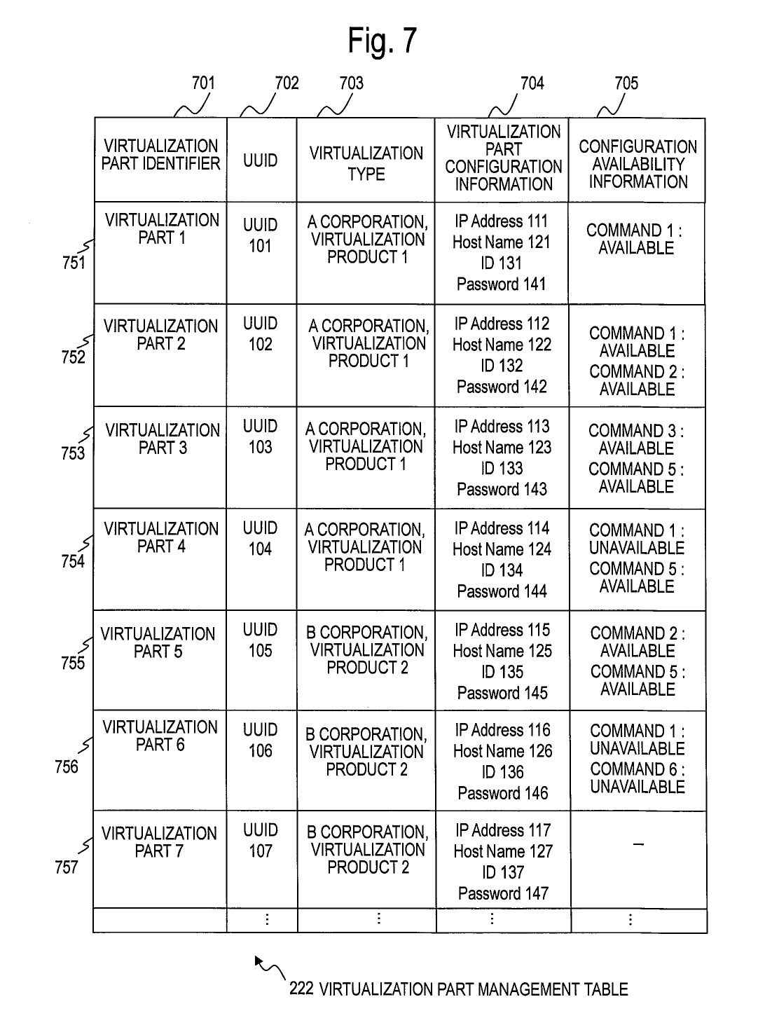

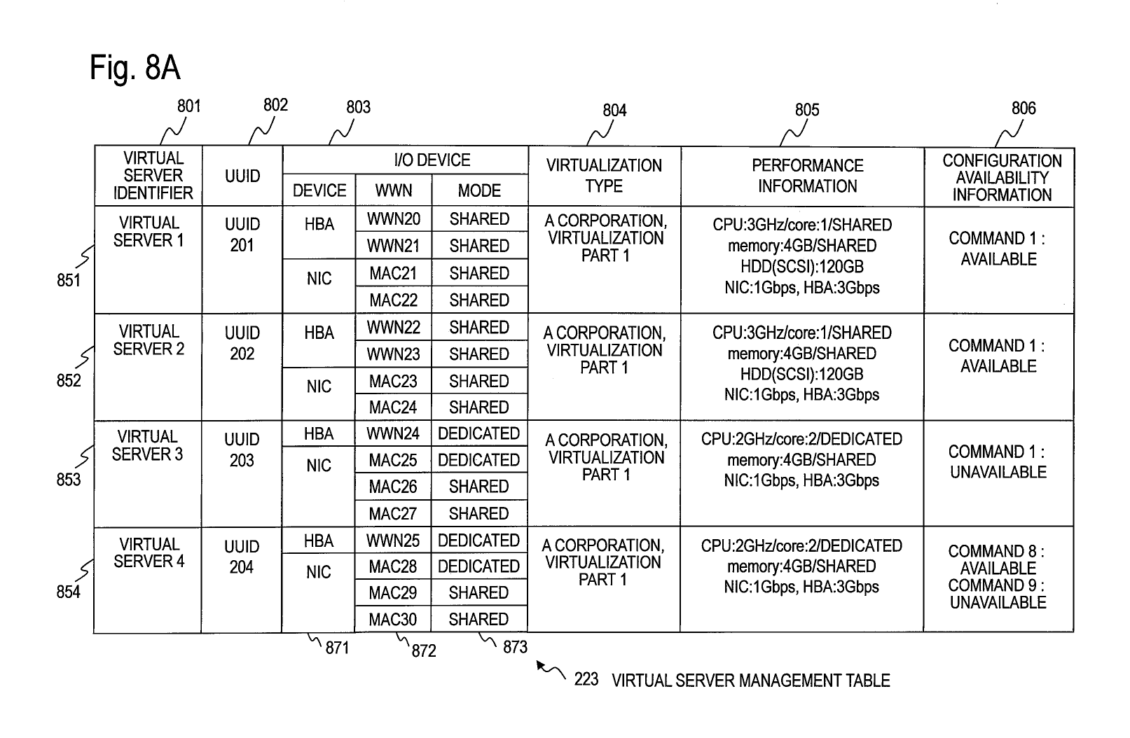

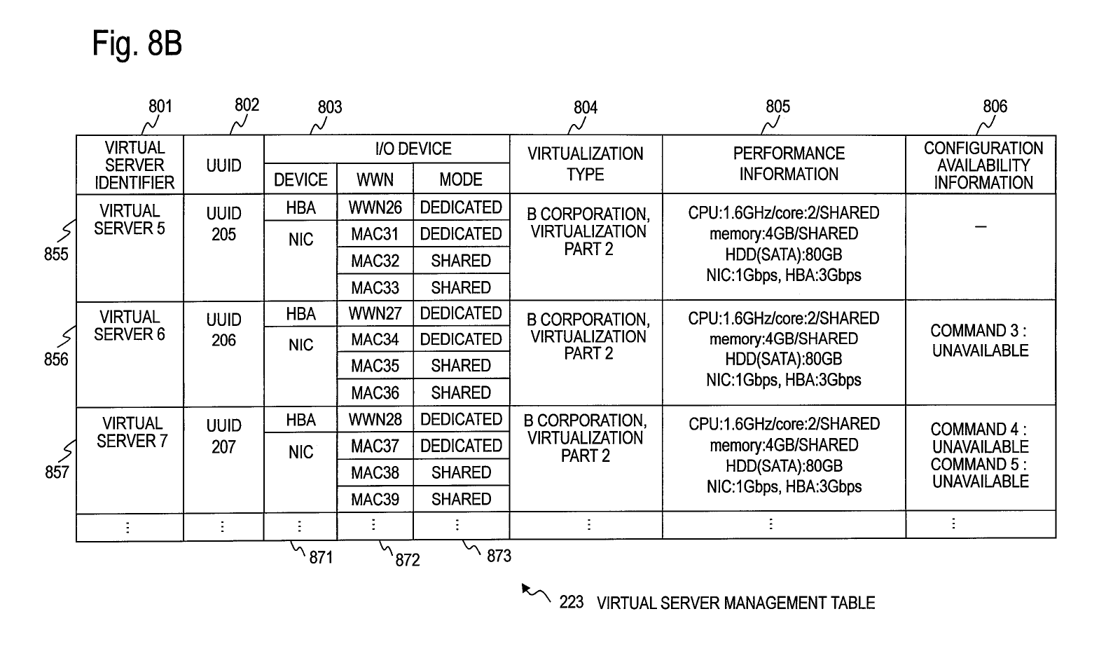

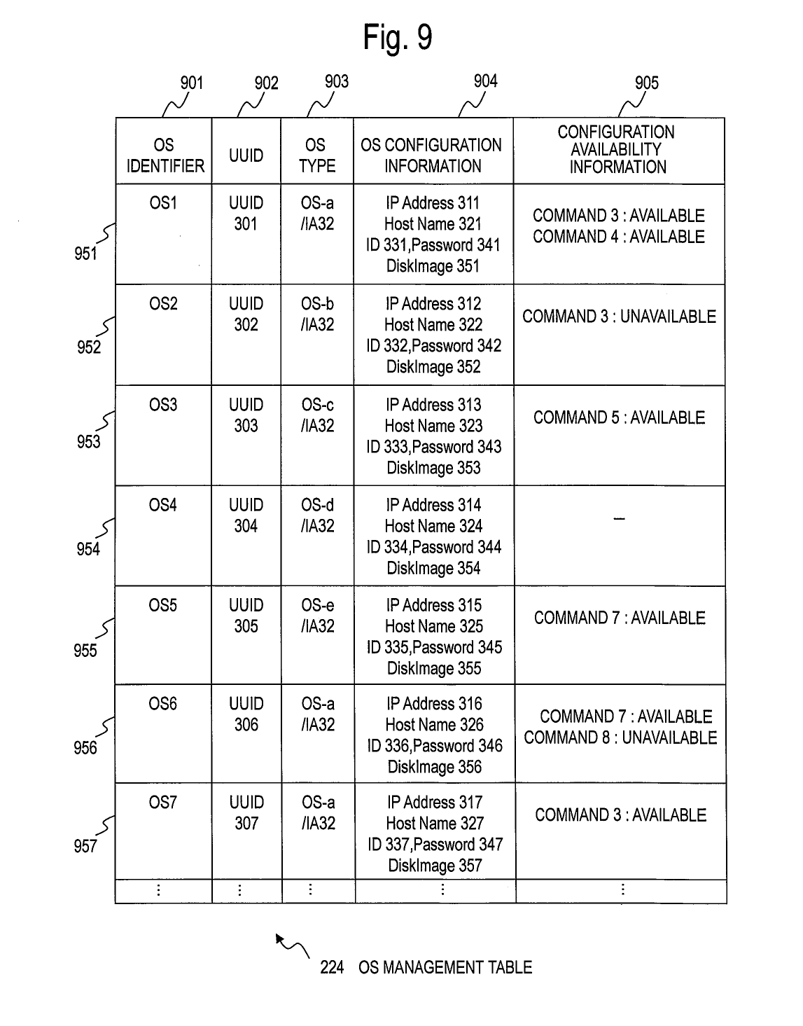

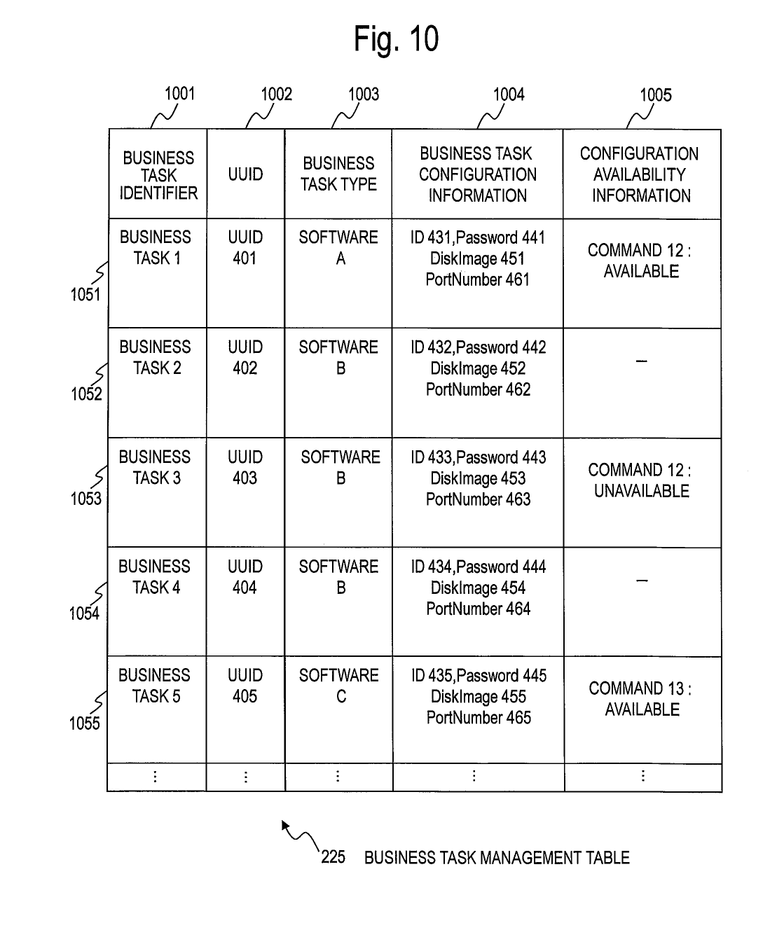

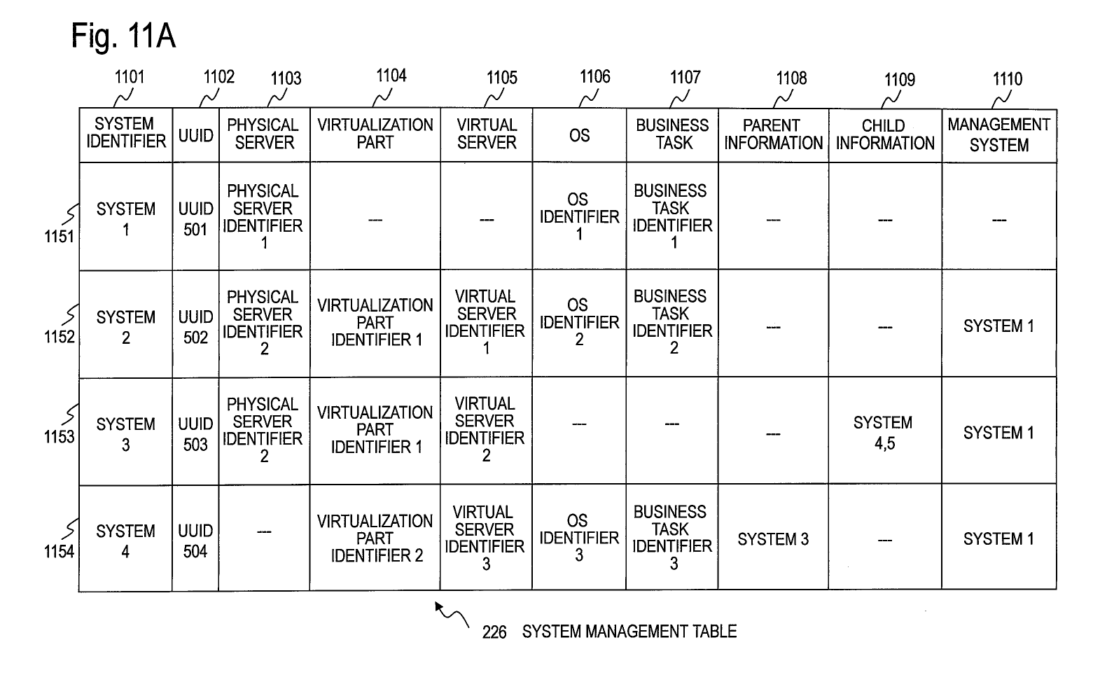

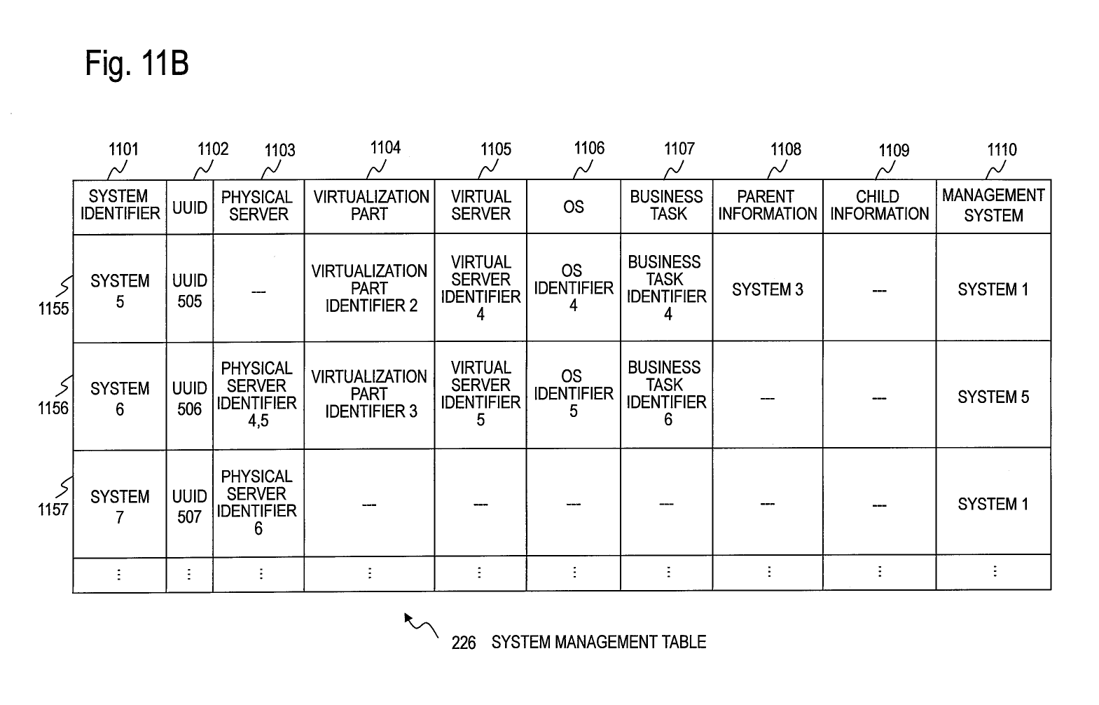

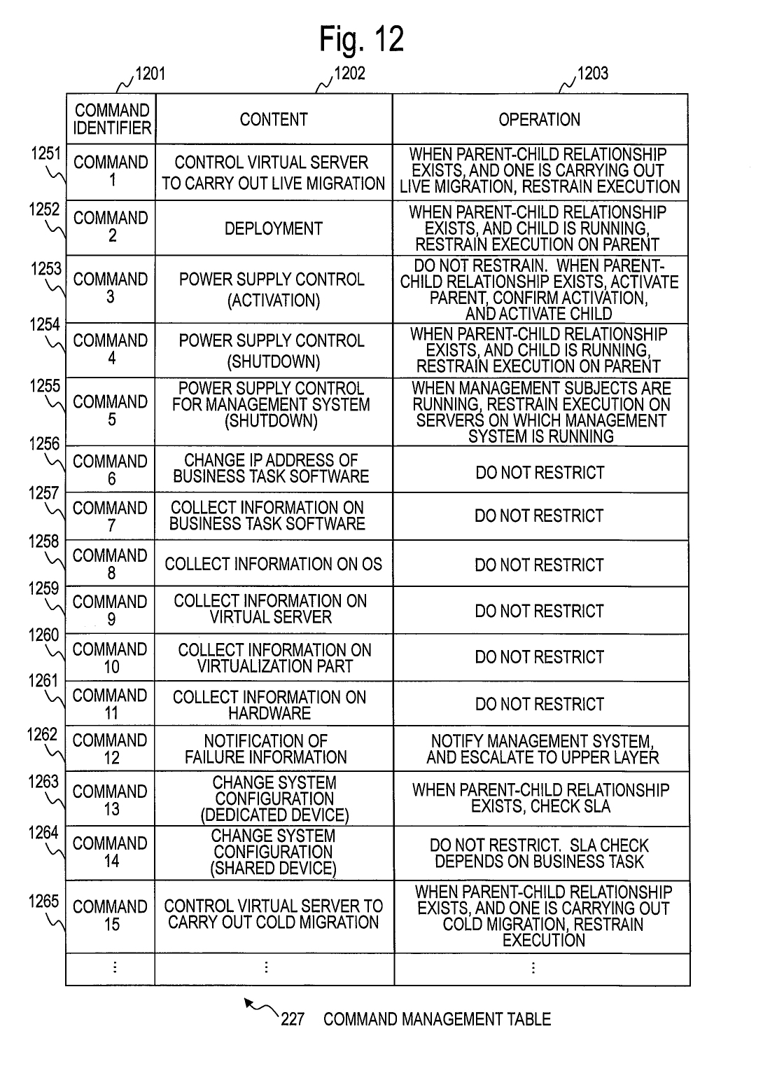

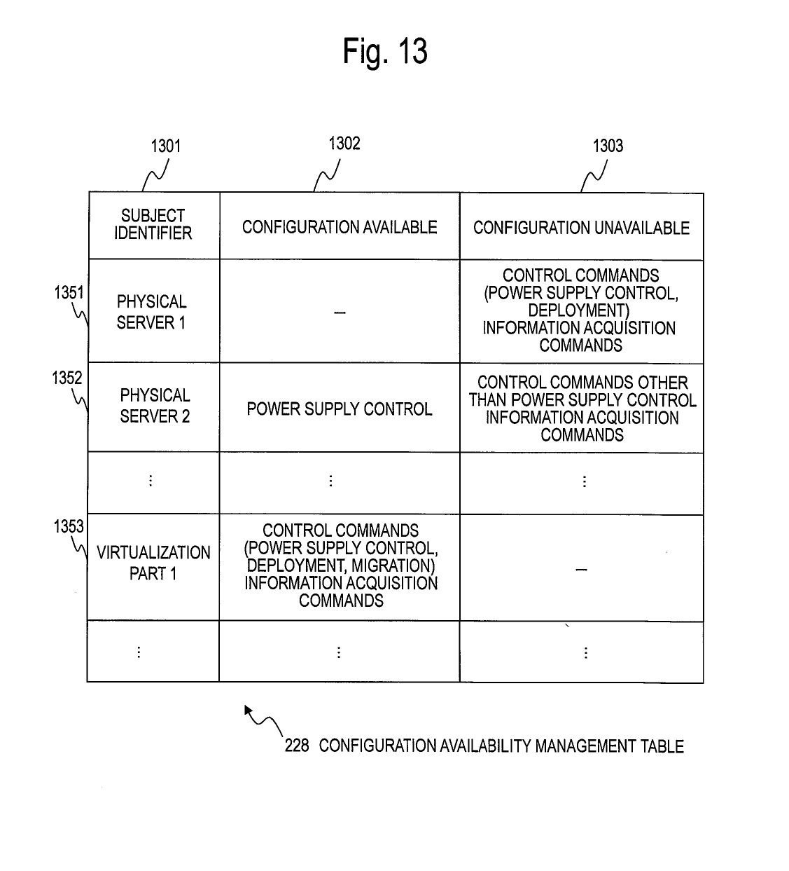

The management table group 111 includes a physical server management table 221 (refer to FIG. 6), a virtualization part management table 222 (refer to FIG. 7), a virtual server management table 223 (refer to FIG. 8), an OS management table 224 (refer to FIG. 9), a business task management table 225 (refer to FIG. 10), a system management table 226 (refer to FIG. 11), a command management table 227 (refer to FIG. 12), and a configuration availability management table 228 (refer to FIG. 13).

Information collection for each of the tables may be automatic collection by using a standard interface and an information collection program, or an input from a console (not shown) of the management server 101 by a system administrator or the like.

The server type of the management server 101 may be any one of a physical server, a blade server, a virtualized server, and a logically or physically divided server, and effects of this invention can be provided by using any one of the servers.

Information such as programs and tables for realizing each of the functions of the control part 110 can be stored in memory devices such as the storage subsystem 105, a non-volatile semiconductor memory, a hard disk drive, and a solid state drive (SSD), and a computer readable non-transitory data storage medium such as an IC card, an SD card, and a DVD.

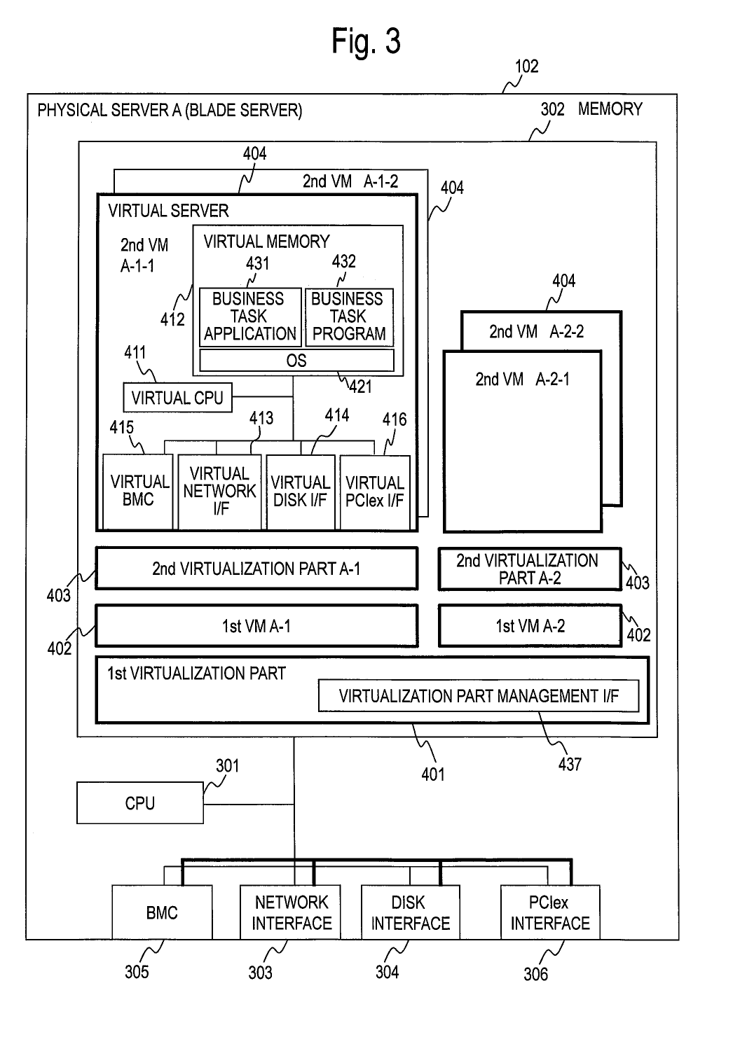

FIG. 3 is a block diagram illustrating a configuration of providing the virtual servers 404 on the physical server 102. FIG. 3 illustrates an example where the server 102 constructs a multi-stage virtual computer including a first virtualization part 401 for assigning the physical computer resources to a plurality of first virtual servers (or logical partitions) 402, and second virtualization parts 403 for assigning computer resources of the first virtual servers 402 to the plurality of virtual servers 404.

First, the physical server 102 includes a CPU 301 for carrying out calculation, a memory 302 for storing programs executed by the CPU 301, and data required for the execution of the programs, a disk interface 304 for making access to the storage subsystem 105 for storing the programs and the data, a network interface 303 for communication performed via an IP network, a BMC 305 for carrying out the power supply control, and controlling the respective interfaces, and a PCI-Express interface 306 for coupling to the PCIex-SW 107.

In the server 102 of FIG. 3, representative one is illustrated for each of the network interface 303, the disk interface 304, and the PCIex interface 306, but a plurality thereof exist. For example, for the respective couplings to the management network 103 and the business task network 104, network interfaces 303 different from each other may be used.

In the memory 302, the first virtualization part 401 for virtualizing the computer resources of the physical server 102 is disposed as a virtualization part on a lower layer, and provides the plurality of second virtualization parts 403, which are virtualization parts on an upper layer, with the computer resources (first virtual servers 402). Moreover, the second virtualization parts 403 generate the plurality of virtual servers 404, and store the plurality of virtual servers 404 in the memory 302. Moreover, the first virtualization part 401 includes a virtualization part management interface 431 as a control interface. It should be noted that each of the second virtualization part 403 also includes a virtualization part management interface (not shown) as a control interface.

The first virtualization part 401 virtualizes the computer resources of the physical server 102 (or the blade server), thereby constructing the plurality of first virtual servers 402. As the first virtualization part 401, for example, a hypervisor, a virtual machine monitor (VMM), or the like can be employed. Moreover, the second virtualization parts 403 further virtualize the computer resources (first virtual servers 402) provided by the first virtualization part 401, thereby generating the plurality of virtual servers 404. As the second virtualization part 403, for example, a hypervisor, a VMM, or the like can be employed.

The virtual servers 404 are constructed by virtual devices (or logical devices) provided by the second virtualization parts 403. As the virtual device according to this embodiment, such an example that the virtual device is constructed by a virtual CPU 411, a virtual memory 412, a virtual network interface 413, a virtual disk interface 414, a virtual BMC 415, and a virtual PCIex interface is described.

Those logical devices are the computer resources (first virtual servers 402) assigned by the first virtualization part 401 to the plurality of the second virtualization parts 403 and further assigned by the second virtualization parts 403 to each of the virtual servers 404.

In the virtual memory 412 of the virtual server 404, an OS 421 is stored, and manages the virtual devices in the virtual server 404. Moreover, on the OS 421, a business application 431 is executed. Moreover, a management program 432 running on the OS 421 provides failure detection, power supply control by the OS, and inventory management.

The first virtualization part 401 manages correspondences between the physical computer resources of the server 102 and the computer resources assigned to the second virtualization parts 403. In this embodiment, such an example that the first virtualization part 401 assigns the first virtual servers 402 to the second virtualization parts 403 is described, but the first virtualization part 401 may directly assign the physical computer resources of the physical server 102 to the second virtualization parts 403. In this case, the first virtual servers 402 can be omitted.

The first virtualization part 401 can dynamically change the computer resources of the server 102 assigned to the plurality of second virtualization parts 403, or can free up the computer resources. Moreover, the first virtualization part 401 holds amounts of the computer resources assigned to the second virtualization parts 403, configuration information, and operation history.

The second virtualization part 403 further virtualizes the computer resources of the first virtual servers 402, and assigns the virtualized computer resources to the plurality of virtual servers 404 (second virtual servers). The second virtualization parts 403 manage a correspondence of computer resources assigned to each of the virtual servers 404 out of the computer resources of the first virtual servers 402. The second virtualization parts 403 can dynamically change the computer resources of the first virtual servers 402 assigned to the plurality of virtual servers 404, or can free up the computer resources. Moreover, the second virtualization parts 403 hold amounts of the computer resources assigned to the virtual servers 404, configuration information, and operation history.

Further, the first virtualization part 401 can forcefully turn on and off the second virtualization parts 403 and the virtual servers 404. Conversely, when the virtual server 404 is running, the OS 421 is running on the virtual server 404, or the business task application 431 or the management program 432 is running on the OS 421, the first virtualization part 401 and the second virtualization part 403 can restrain the forceful power supply operations. It should be noted that a timing when the power supply operation is restrained needs to be changed depending on the state of the virtual computers. According to this invention, the power supply operation can be configured so that the control for the lower layer is restrained depending on the operation state of the upper layer. Moreover, the management server 101 can provide a graphic user interface (GUI) for controlling the power supply operation command. The GUI can be operated via the console (not shown) of the management server 101 or a management terminal (not shown). For example, if the GUI for the power supply operation restrains the power supply operation to the lower layer depending on the operation state of the upper layer, the elements (first virtualization part 401 and the second virtualization parts 403) of the lower layer may be hidden from display or inactivated (unselectable).

Moreover, in addition to the power supply operation command, by providing restriction control for preventing the same function (such as live migration and deployment) from being simultaneously executed on the upper and lower layers, an unintended stop of a business task and the computer system can be avoided.

Further, by running the virtual servers (second virtual servers) 404 on the first virtual servers 402, the virtual servers are brought into a nested state. Also in this case, as described later, the management server 101 can avoid the stop of a business task, which is not intended by the system administrator, by restraining a state change of the lower layer of the multi-stage virtual computer depending on the state of the upper layer thereof, or by restraining a state change of the upper layer depending on the state of the lower layer.

On this occasion, according to this embodiment, the first virtualization part 401 for providing the first virtual servers 402 acquired by virtualizing the hardware of the physical server 102 is configured as a first layer, the second virtualization parts 403 for providing the virtual servers 404 acquired by further virtualizing the computer resources of the first virtual servers 402 are configured as a second layer, and the OSs 404 are configured as a third layer. Then, the third layer side is considered as the upper layer, and the first layer side is considered as the lower layer. In examples of the migration and the deployment, the second layer and the first layer are treated respectively as the upper layer and the lower layer.

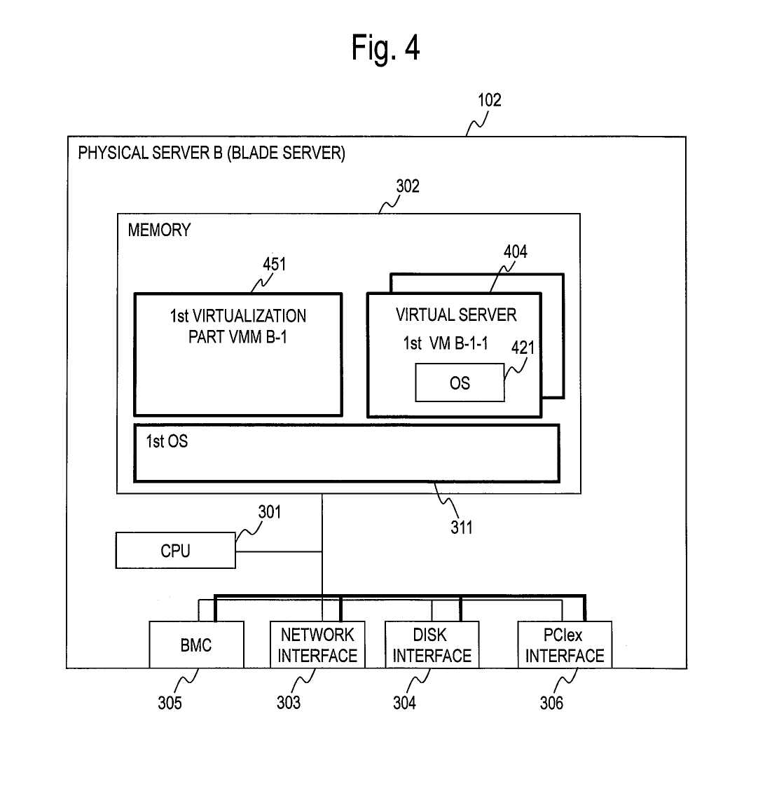

FIG. 4 is a block diagram illustrating another configuration example of the physical server 102 to which the server virtualization technology is applied. Even if the server 102 is a blade server, the configuration is the same.

The hardware of the server 102 is the same as that of FIG. 3. In the memory 302, a host OS 311, a virtualization part 451, and the virtual servers 404 are provided. The virtualization part 451 is constructed by a VMM, and assigns the computer resources of the server 102 to the plurality of virtual servers 404. On each of the virtual servers 404, the guest OS 421 is executed, and, on the guest OS 421, the business task application 431 and the management program 432 are executed.

The virtualization part 451 corresponds to the first virtualization part 401 illustrated in FIG. 3, and manages a correspondence between the physical computer resources of the server 102 and computer resources to be assigned to the virtual servers 404. Then, the virtualization part 451 can dynamically change the computer resources of the server 102 assigned to the plurality of virtual servers 404, or can free up the computer resources. Moreover, the virtualization part 451 holds amounts of the computer resources assigned to the virtual servers 404, configuration information, and operation history.

In this example, the host OS 311 is on the first layer, and the virtualization part 451 and the virtual server 404 are on the second layer.

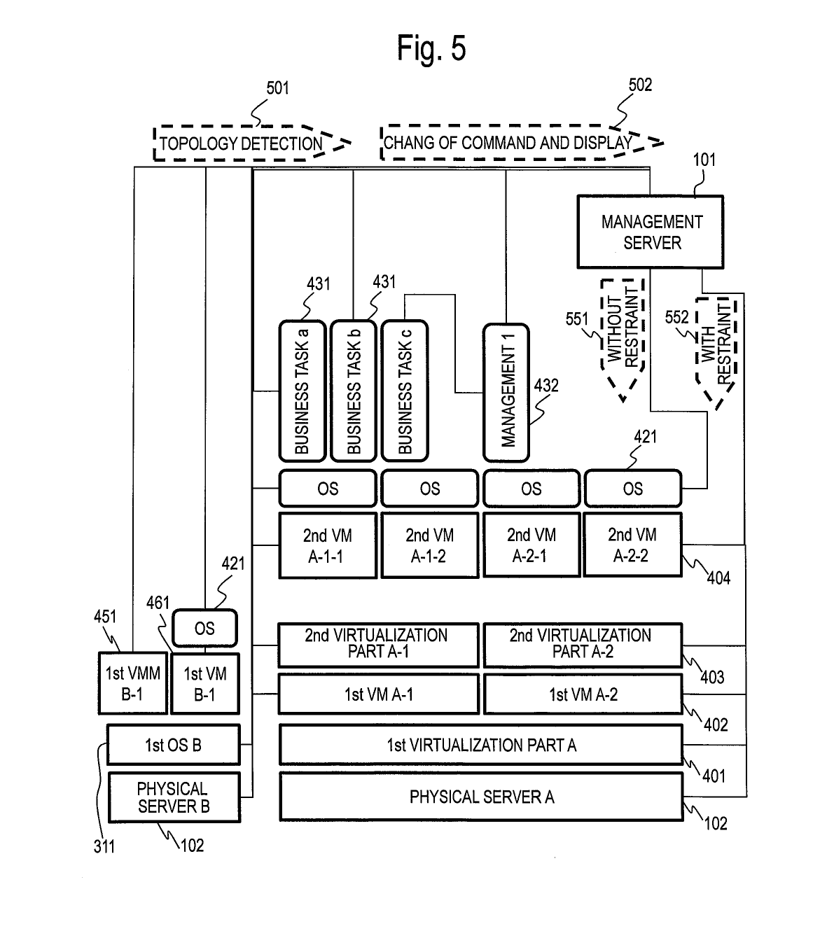

FIG. 5 is a block diagram schematically illustrating this invention. FIG. 5 illustrates an example of the virtual computer system where two servers 102 (physical servers A and B) respectively provide the virtual servers 404.

The physical server A is constructed by the multi-stage virtual computer as illustrated in FIG. 3, and includes the first virtualization part 401 executed on the lower layer, the plurality of second virtualization parts 403 executed on the upper layer, and the virtual servers 404 executed on the second virtualization parts 403. The physical server B constructs the single-layer virtual computer where the virtualization part 451 executed on the host OS 311 operates the virtual servers 404 as illustrated in FIG. 4.

The management server 101 carries out topology detection 501 to detect, as a topology, a coupling relationship among the physical server 102, the first virtualization part 401, the second virtualization parts 403, the virtual servers 404, the OSs 421, the business applications 431, and the management program 432. The management server 101 detects, as the coupling relationship, the relationship among the respective virtualization parts operating on the physical server 102, the virtual servers 404 operating on the respective virtualization parts, and the respective applications operating on the virtual servers 404.

All subjects of management (such as the virtual servers 404 and the first virtualization part 401) are coupled to the management server 101, but the subjects may be coupled to the management server 101 via a management system. The management system is used if the management program 432 manages other virtual servers 404, business task applications 431, first virtualization part 401, second virtualization part 403, and physical servers 102. It should be noted that the management program 432 can include the control part 110 and the management table group 111 of the management server 101. This case is equivalent to such a configuration that the management server 101 is executed on the virtual server 404. In other words, any one of the plurality of the virtual servers 404 may function as the management server 101.

Then, the management server 101 detects an operation state (ON or OFF of the power supply) of the management subject before a command is issued to the management subject.

When the management subject is running, the management server 101 restrains a command to cause the state of the lower layer (virtualization part) in the coupled relationship with the management subject to transition to a turned-off state (552).

Moreover, the management server 101 restrains (552) migration of the management subject (migration of the virtual server) to a location that is not topologically coupled. On the other hand, the management server 101 does not restrain the power supply operation command directed to the OS on the upper layer (551). The determination as to whether the command is restrained 552 or is not restrained 551 is made by the management server 101 for each of the management subjects as described later. In other words, the management server 101 determines whether a command is restrained or is issued based on the operation state and the coupling relationship of the management subject to which the command is to be issued.

Moreover, while migration in the running state is carried out on the lower layer such as the first virtualization part A, when the same function is carried out on the upper layer such as the virtual server 404, the function executions can fail even when each of the functions realizes the migration in the running state. The management server 101 thus restrains the simultaneous execution of the same functions on the lower layer and the upper layer. Moreover, even when the states of the upper layer and the lower layer are inverted, the management server 101 imposes the same restraint. If the same functions are restrained from being carried out simultaneously, the simultaneous execution can be avoided by suspending the execution of the function and executing again the function after a certain time has elapsed.

Moreover, while the migration is being carried out on the upper layer, when the execution command of the same function is issued to the lower layer, the management server 101 can provide the same effect as that of suspending of the execution in order to avoid a stop of business task by stopping the migration on the upper layer 101, controlling the migration to be executed on the lower layer, and then carrying out again the migration on the upper layer. Further, there may be provided such an operation that, after the migration on the lower layer is carried out, the necessity of the migration on the upper layer is determined again, and the migration is carried out if the migration is necessary and the migration is not carried out if the migration is not necessary. With this operation, it is possible to realize an efficient resource operation, which focuses more on an arrangement of the virtual servers, while the simultaneous execution is avoided. On this occasion, the determination of the necessity of the migration is determination as to whether or not the operation is efficient, and a determination from a different point of view can provide effects such as an increase in fault tolerance and an increase in performance. Other than the stop of the execution, the simultaneous execution can be avoided by restraining the execution of the migration on the lower layer until the migration on the upper layer is completed, and carrying out the migration on the lower layer after the migration on the upper layer is completed. Moreover, if the destination of the migration on the upper layer is a location that is not coupled on the network, the management server 101 restrains the migration. However, if the destination on the upper layer can be coupled on the network as a result of the migration on the lower layer, the migration on the upper layer is carried out after the migration on the lower layer. As a result, a more flexible resource operation can be provided. For example, such an effect that transition from a development environment to an actual operation environment is facilitated can be expected.

Moreover, when the management server 101 issues a start command for power supply or an activation command to the upper layer, if the lower layer is not activated, the management server 101 activates the lower layer first, confirms the activation of the lower layer, and then issues the start command for the power supply to the upper layer.

The management server 101 refers to the detected topology, and configures a command or function to be restrained from being executed as described above for each of the management subjects. A description is later given of the configuration.

FIGS. 6A and 6B show an example of the physical server management table 221. The physical server management table 221 is configured by the management server 101 acquiring, at a predetermined cycle, information on the physical servers 102 subject to the management.

A column 601 stores physical server identifiers, and the identifier is used to uniquely identify each of the physical servers. An input of data to be stored in a column 601 can be omitted by specifying any one of or a combination of a plurality of columns used in this table. Moreover, the identifiers may be automatically assigned, for example, in an ascending order.

A column 602 stores universal unique identifiers (UUIDs). The UUID is an identifier specified in a format for avoiding redundancy. Therefore, an identifier for ensuring reliable uniqueness can be provided by holding the UUID for each of the physical servers 102. It should be noted that an identifier used by the system administrator to identify a server only needs to be used in the column 601, and does not pose a problem unless redundant identifiers are used for servers of the management subjects. Thus, although the use of the UUID is preferred, but the use thereof is not indispensable. For example, as the server identifier in the column 601, a MAC address, a world wide name (WWN), or the like may be used.

A column 603 (columns 621 to 622) stores information on the physical adaptors (303 to 306). The column 621 stores device types. The column 621 stores types such as host bus adaptor (HBA), NIC, converged network adaptor (CAN), and the like. The column 622 stores WWNs, which are identifiers of the HBAs, and MAC addresses, which are identifiers of the NICs.

A column 604 stores information on the switches 103 and 104 to which the physical servers 102 are coupled via the physical adaptors. The column 604 stores types, coupled ports, and security configuration information.

A column 605 stores models of the physical servers 102. The model is information on an infrastructure, and is information providing knowledge on performances and system limits which can be configured. It should be noted that the values in the column 605 may be configured from an input apparatus (not shown) by the system administrator or the like.

A column 606 stores configurations of the physical servers. The column 606 stores architectures of processors, physical location information on a chassis and slots, and characteristic functions (presence/absence of symmetric multi-processing (SMP) between blades, an HA configuration, and the like). The information stored in the column 606 is information on the infrastructure as that stored in a column 605.

A column 607 stores performance information on the physical servers. It should be noted that the values in the column 607 may be configured from an input apparatus (not shown) by the system administrator or the like.

A column 608 stores configuration availability information. Information on availability of configuration is stored for commands in the command management table 227. The management server 101 can determine whether or not the respective commands can be configured to each of the management subjects (such as the virtualization parts on the physical servers 102) by referring to the information. If the configuration is available, the availability represents that such a configuration that, for a management subject, after the execution of a command is restrained or another condition is satisfied, the determination as to whether or not to execute the command is made, and the command is then executed can be carried out. Moreover, conversely, if the configuration is not available, the restraint of a command and the like cannot be configured for the management subject, and thus, for example, the management subject may be excluded from selection subjects when the configuration availability information is displayed on the GUI provided by the management server 101. The GUI can be operated by the console (not shown) of the management server 101 and the management terminal (not shown). On this GUI, for example, when the power supply operation on the lower layer is restrained depending on the operation condition of the upper layer, the configuration availability information on the elements on the lower layer (the first virtualization part 401 and the second virtualization parts 403) may be displayed as inactive, thereby preventing an input operation from the console from being received.

FIG. 7 illustrates the virtualization part management table 222. The virtualization part management table 222 is configured by the management server 101 acquiring, at a predetermined cycle, information on the first virtualization parts 401 and the second virtualization parts 403 subject to management.

A column 701 stores identifiers for the virtualization parts (the first virtualization part 401 and the second virtualization parts 403), and each of the virtualization parts is uniquely identified by the identifier. An input of data to be stored in the column 701 can be omitted by specifying any one of or a combination of a plurality of columns used in this table. Moreover, the identifiers may be automatically assigned, for example, in an ascending order.

A column 702 stores UUIDs. The management server 101 or the like assigns a UUID as a unique ID to each of the virtualization part identifiers.

A column 703 stores virtualization types. The virtualization type represents a virtualization product or a virtualization technology, and enables clear determination of a control interface and a difference in function. Version information may be included. If the virtualization part includes an original management function, a name or management interface of the management function may be included.

A column 704 stores virtualization part configuration information. The virtualization part configuration information is, for example, an IP address required for coupling to the virtualization parts.

A column 705 stores configuration availability information. The column 705 stores the configuration availability corresponding to the command in the command management table 227 described later. By referring to the information, whether a command can be configured for each of the first virtualization part 401 and the second virtualization parts 403, which is a management subject of the management server 101, can be determined. A value in the column 705 represents that if the configuration is available, such a configuration that the execution of a command is restrained for a management subject, or after another condition is satisfied, the determination as to whether or not to execute the command is made, and the command is then executed for a management subject can be applied.

Moreover, conversely, if the configuration is not available, the restraint of a command and the like cannot be configured for the management subject, and hence, for example, the management subject may be excluded from subjects of selection when the configuration availability information is displayed on the GUI provided by the management server 101. The GUI can be operated by the console (not shown) of the management server 101 and the management terminal (not shown). On this GUI, for example, when the power supply operation on the lower layer is restrained depending on the operation condition of the upper layer, the configuration availability information on the elements on the lower layer (the first virtualization part 401 and the second virtualization parts 403) may be displayed as inactive, thereby preventing an input operation from the console from being received.

FIGS. 8A and 8B illustrate the virtual server management table 223. The virtual server management table 223 manages the computer resources assigned to the virtual servers 404. The virtual server management table 223 can be configured when the virtual server management server 151 generates or changes the virtual server 404.

A column 801 stores identifiers for the virtual servers 404, and each of the identifiers is used to uniquely identify each of the virtual servers.

A column 802 stores UUIDs. The UUID is a value assigned by, for example, the virtual server management server 151. It should be noted that an identifier used by the system administrator to identify a server only needs to be used in the column 801, and does not pose a problem unless redundant identifiers are used for servers of the management subjects. Thus, although the use of the UUID is preferred, the use thereof is not indispensable. For example, as the virtual server identifier in the column 801, a virtual MAC address, a virtual WWN (stored in a column 872), or the like may be used. Moreover, an OS may employ an original identifier for maintaining uniqueness, and, in this case, the ID employed by the OS may be used, or an original ID may be held for maintaining uniqueness.

A column 803 (columns 871 to 873) stores information on virtual adaptors. The column 871 stores virtual device types. The column 871 stores values of virtual HBAs, virtual NICs, virtual CNAs, and the like. The column 872 stores identifiers of the I/O devices such as virtual WWNs, which are identifiers of the virtual HBAs, and virtual MAC addresses, which are identifiers of the virtual NICs. The column 873 stores usage modes of the virtual adaptors, which include a shared mode and a dedicated mode.

The virtual device includes a mode in which a used physical device is used in a shared manner and a mode in which the used physical device is used in a dedicated manner. In the shared mode, other virtual devices simultaneously use the physical device. In the dedicated mode, the virtual device solely uses the physical device.

A column 804 stores virtualization types of the virtual servers 404. The virtualization type represents a virtualization product or a virtualization technology, and enables clear determination of a control interface and a difference in function. Version information may be included. If the virtualization server includes an original management function, a name or management interface of the management function may be included.

A column 805 stores performance information on the virtual servers 404. The performance information includes performance information on a CPU assigned to the virtual server, a capacity of an assigned memory, a capacity of a storage, and performance information on an I/O device.

A column 806 stores configuration availability information. The configuration availability information stores information on availability of configuration for the commands in the command management table 227. The management server 101 can determine whether the respective commands can be configured for each of the virtual servers 404 subject to the management by referring to the information. If the configuration availability information represents that the configuration is available, the availability represents that such a configuration that the execution of a command is restrained for a management subject, or after another condition is satisfied, the determination as to whether or not to execute the command is made, and the command is then executed for a management subject can be carried out.

Moreover, conversely, if the configuration is not available, the restraint of a command and the like cannot be configured for the management subject, and hence, for example, the management subject may be excluded from subjects of selection when the configuration availability information is displayed on the GUI provided by the management server 101. The GUI can be operated by the console (not shown) of the management server 101 and the management terminal (not shown). On this GUI, for example, when the power supply operation on the lower layer is restrained depending on the operation condition of the upper layer, the configuration availability information on the elements on the lower layer (the first virtualization part 401 and the second virtualization parts 403) may be displayed as inactive, thereby preventing an input operation from the console from being received.

FIG. 9 illustrates the OS management table 224. Information on which OS is configured in what way is managed. The OS management table 224 is configured by the management server 101 acquiring, at a predetermined cycle, information on the OSs from the virtual servers 404 subject to the management.

A column 901 stores OS identifiers, and the identifier is used to uniquely identify an OS.

A column 902 stores UUIDs. The UUID is a value assigned by, for example, the management server 101. The UUID is a candidate of the OS identifier stored in the column 901, and is very effective for server management across a wide range. It should be noted that an identifier used by the system administrator to identify a server only needs to be used in the column 901, and does not pose a problem unless redundant identifiers are used for servers of the management subjects. Thus, although the use of the UUID is preferred, the use thereof is not indispensable. For example, as the OS identifier in the column 901, an OS configuration information (stored in a column 904) may be used.

A column 903 stores OS types. The column 903 stores types, vendors, compliant CPU architectures, and the like of the OS.

The column 904 stores the OS configuration information. The column 904 stores IP addresses, host names, IDs, passwords, disk images, and the like. The disk image refers to a disk image of a system disk when the OS before and after the configuration is delivered to the physical server 102 or the virtual server 404. The information on the disk image stored in the column 904 may include data disk.

A column 905 stores configuration availability information. The configuration availability information stores information on availability of configuration for the commands in the command management table 227 described later. The management server 101 can determine whether the respective commands can be configured for each of the OSs by referring to the information. If the configuration availability information represents that the configuration is available, the availability represents that such a configuration that the execution of a command is restrained for a management subject, or after another condition is satisfied, the determination as to whether or not to execute the command is made, and the command is then executed for a management subject can be carried out.

Moreover, conversely, if the configuration is not available, the restraint of a command and the like cannot be configured for the management subject, and hence, for example, the management subject may be excluded from subjects of selection when the configuration availability information is displayed on the GUI provided by the management server 101. The GUI can be operated by the console (not shown) of the management server 101 and the management terminal (not shown). On this GUI, for example, when the power supply operation on the lower layer is restrained depending on the operation condition of the upper layer, the configuration availability information on the elements on the lower layer (the first virtualization part 401 and the second virtualization parts 403) may be displayed as inactive, thereby preventing an input operation from the console from being received.

FIG. 10 illustrates the business task management table 225. Information on what business tasks and software include what configurations are managed. The business task management table 225 is configured by the management server 101 acquiring, at a predetermined cycle, information on the business applications 431 from the OSs of the virtual servers 404 subject to the management.

A column 1001 stores identifiers for the business applications 431, and each of the identifiers is used to uniquely identify each of the business tasks.

A column 1002 stores UUIDs. The UUID is a value assigned by, for example, the management server 101. The UUID is a candidate of the business task identifier stored in the column 1001, and is very effective for server management across a wide range. It should be noted that an identifier used by the system administrator to identify the business application 431 only need to be used in the column 1001, and does not pose a problem unless redundant identifiers are used for servers of the management subjects. Thus, although the use of the UUID is preferred, the use thereof is not indispensable. For example, as the business task identifier in the column 1001, business task configuration information (stored in a column 1004) may be used.

A column 1003 stores information on business task types. What business tasks and software are running are stored. With this, a command execution policy from business task requirements is defined, which enables a command configuration corresponding to the business task and software such as availability of execution of the command, restraint, conditional execution, and conditional restraint.

A column 1004 stores business task types, and stores information on software identifying the business tasks such as used applications and middleware. Logical IP addresses, IDs, passwords, disk images used in the business tasks, port numbers used in the business tasks, and the like are stored. The disk image refers to a disk image of a system disk when the business task before and after the configuration is delivered to the OS on the physical server 102 or the virtual server 404. The information on the disk image stored in the column 1004 may include data disk.

A column 1005 stores configuration availability information. The configuration availability information stores availability of configuration for the commands in the command management table 227. The virtual server management server 101 can determine whether the respective commands can be configured for each of the management subjects by referring to the information. If the configuration availability information represents that the configuration is available, the availability represents that such a configuration that the execution of a command is restrained for a management subject, or after another condition is satisfied, the determination as to whether or not to execute the command is made, and the command is then executed for a management subject can be carried out.

Moreover, conversely, if the configuration is not available, the restraint of a command and the like cannot be configured for the management subject, and hence, for example, the management subject may be excluded from subjects of selection when the configuration availability information is displayed on the GUI provided by the management server 101. The GUI can be operated by the console (not shown) of the management server 101 and the management terminal (not shown). On this GUI, for example, when the power supply operation on the lower layer is restrained depending on the operation condition of the upper layer, the configuration availability information on the elements on the lower layer (the first virtualization part 401 and the second virtualization parts 403) may be displayed as inactive, thereby preventing an input operation from the console from being received.

FIGS. 11A and 11B show the system management table 226. The system management table 226 is configured by the system administrator from an input apparatus (not shown). The system management table 226 manages a system configuration which is a combination of the physical servers 102, the first virtualization parts 401, the second virtualization parts 403, the virtual servers 404, the OSs 421, and the business tasks 431 managed by the physical server management table 221, the virtualization part management table 222, the virtual server management table 223, the OS management table 224, and the business task management table 225. Moreover, the system management table 226 manages a management system for managing parent-child relationships (upper layers or lower layers) among systems.

The column 1101 stores system identifiers, and the identifier is used to uniquely identify a business task.

A column 1102 stores UUIDs. The UUID is a value assigned by, for example, the management server 101. The UUID may be realized as a combination of all or a part of columns 1103 to 1107, or may be independently generated. The UUID needs to be unique at least in a range managed by the management server 101.

The column 1103 stores the physical server identifiers 601. The column 1104 stores the virtualization part identifiers 701. The column 1105 stores the virtual server identifiers 801. The column 1106 stores the OS identifiers 901.

The column 1107 stores the business task identifiers (1001). Although not shown in the tables, management of racks, floors, receptacle boxes, breakers, centers, presence/absence of the HA configuration, network infrastructure information, power grids, network topologies, network switches, fiber channels, capacities of respective switches, network bandwidths, and the like can provide the effect of this invention of preventing an operation error on the system across them.

A column 1108 stores the identifiers (1101) of systems serving as parents. For example, the column 1108 of a system 4 (1154) represents that the system has, as a parent (upper layer), a system identifier, “SYSTEM 3” from the column 1101.

A column 1109 stores the identifiers (1101) of systems serving as children. For example, the column 1109 of a system 3 (1153) represents that the system has, as children (lower layers), system identifiers, “SYSTEMS 4 and 5” from the column 1101.

A management system 1110 stores identifiers 1101 of systems managing the systems in the respective entries.

FIG. 12 shows the command management table 227. The command management table 227 defines operations corresponding to commands issued by the system administrator from an input apparatus (not shown).

The operation corresponding to the command may be provided by a user (or system administrator), or may be determined so that if the parent-child relationship exists, while a certain command is being executed, another same command is restrained from being executed. However, it is preferred that commands for acquiring information not be restrained, and the restraint be limited to commands causing a change in state.

A column 1201 stores command identifiers 1201. The identifier only needs to identify a command, and an original identifier may be generated and stored, or may be an UUID or the like.

A column 1202 stores contents of the commands. A column 1203 stores operations corresponding to the commands in the column 1202. As a result, such definitions as restraining the command execution and permitting the command execution can be made.

An entry 1251 describes an operation for controlling the virtual server to carry out the live migration. It is defined that if the upper layer and the lower layer exist and the parent-child relationship exists, while the live migration is being carried out on one layer, the live migration is restrained on the other layer. As a result, a failure in the live migration, and a stop of the business task due to the failure can be avoided. Moreover, as another operation, if the live migration is being carried out on the upper layer, after the live migration on the upper layer is stopped and the live migration on the lower layer is carried out, the live migration on the upper layer is again carried out, thereby carrying out both the live migrations and preventing both the live migrations from failing due to simultaneous execution to stop the business task.

In the live migration, when the command to carry out the live migration is issued to the first virtualization part 401 on the lower layer while the live migration is being carried out by the second virtualization part 403 on the upper layer, the live migration on the upper layer needs to be evaluated again. Therefore, first, the live migration is stopped on the upper layer, and after the live migration is carried out on the lower layer first, whether or not the live migration is necessary on the upper layer is evaluated again, or the live migration is carried out. After the reevaluation, if the re-execution is determined to be necessary, the live migration on the upper layer is carried out again.

In addition to the live migration, in a case where a function specific to the virtualization technology is simultaneously carried out by the first virtualization part 401 and the second virtualization part 403 respectively on the upper layer and the lower layer, the same processing can efficiently operate the resources, and can avoid an unexpected system stop.

An entry 1252 defines an operation relating to the deployment. It is defined that when an upper layer and a lower layer exist between systems and a parent-child relationship exists in the system management table 226 and when the upper layer is running, deployment to the lower layer is restrained from being executed. As a result, other first virtualization parts 401, second virtualization parts 403, and OSs 421 are restrained from being deployed to the physical server 102 on which the virtual server 404 is running, and the stop of the business task on the upper layer due to the deployment to the lower layer is avoided.

An entry 1253 describes an operation relating to activation of the power supply control. The execution is not restrained regardless of absence/presence of the parent-child relationship, but when the upper layer and the lower layer exist and the parent-child relationship exists, the lower layer is activated, and after the activation of the lower layer is confirmed, a command is issued to the upper layer. As a result, the upper layer can be surely activated.

An entry 1254 describes an operation relating to shutdown of the power supply control. When the upper layer and the lower layer exist and the parent-child relationship exists and when the upper layer is running, the same command is restrained from being executed on the lower layer. As a result, the stop of the business task running on the upper layer caused by an operation error of a user or the like can be avoided. The shutdown of the power supply control can include sleep and hibernation.

An entry 1255 describes an operation relating to shutdown of the power supply control for the management system. When a management subject is running, when the upper layer and the lower layer exist and the parent-child relationship exists and when the upper layer is running, the same command is restrained from being executed on the lower layer. Moreover, the same command is restrained from being executed on management subjects (the physical server 102, the first virtualization parts 401, the second virtualization parts 403, the virtual servers 404, the OSs 421, and the business task applications 431) on which the management system is running. As a result, the stop of the business task operating on the upper layer caused by an operation error of a user can be avoided. The shutdown of the power supply control for the management system can include the sleep and the hibernation.

An entry 1256 describes an operation relating to an IP address change of business task software. In this case, regardless of existence of the upper layer and the lower layer, a command is not restrained.

An entry 1257 to and 1261 describe operations relating to information collection. In this case, regardless of existence of the upper layer and the lower layer, a command is not restrained.

An entry 1262 describes an operation relating to notification of failure information. In this case, when the upper layer and the lower layer exist and the parent-child relationship exists, the failure information is notified to the management system, and escalation of the failure information to the upper layer is also carried out. As a result, a failure extent can be transmitted, and the influence extent can be easily identified.

An entry 1263 describes an operation for carrying out a change of a dedicated device out of changes in the system configuration. When the upper layer and the lower layer exist between systems and the parent-child relationship exists, the management server 101 checks the service level agreement (SLA), thereby checking whether or not a violation of the SLA is to be generated by the system configuration change. If the SLA violation is to be generated, the change is restrained, to thereby avoid a decrease in business task performance and a stop of the business task due to an operation error and the like by the user and the system administrator.

An entry 1264 describes an operation for carrying out a change of a shared device out of changes in the system configuration. When the upper layer and the lower layer exist between systems and the parent-child relationship exists, the SLA is not checked. However, depending on business task requirements, whether an SLA violation is to be generated by the system configuration change or not is checked. If the SLA violation is to be generated, the change is restrained, to thereby avoid a decrease in business task performance and a stop of the business task due to an operation error and the like by the user and the system administrator.

An entry 1265 describes an operation for carrying out a cold migration of the virtual server 404. It is defined that when the upper layer and the lower layer exist and the parent-child relationship exists, while the cold migration is being carried out on one layer, the migration is restrained on the other layer. As a result, a failure in the cold migration, and a stop of the business task due to the failure can be avoided.

In this embodiment, the management server 101 acquires the command 1201 directed to the physical server 102 or each of the virtualization parts as the management subjects, and executes or restrains the command depending on the operation 1203.

Moreover, regarding the configuration of the operations and the like, a command to be restrained may be configured by an input on a screen (GUI) provided by the management server 101, or by a method of configuring each of the management subjects including the execution function so as to restrain the execution of the command.

FIG. 13 shows a configuration availability management table 228. The configuration availability management table 228 is configured by the management server 101 as described later. Alternatively, the system administrator may configure the configuration availability management table 228 from the console (not shown) of the management server 101.

A column 1301 stores identifiers of management subjects (the physical server identifiers 601, the virtualization part identifiers 701, the virtual server identifiers 801, the OS identifiers 901, and the business task identifiers 1001).

A column 1302 stores commands for which the restraint of the command can be configured. A column 1303 stores commands for which the restraint of the command cannot be configured.

As a result, the management server 101 can refer to the availability of the configuration relating to the restraint of the respective commands for each of the management subjects.

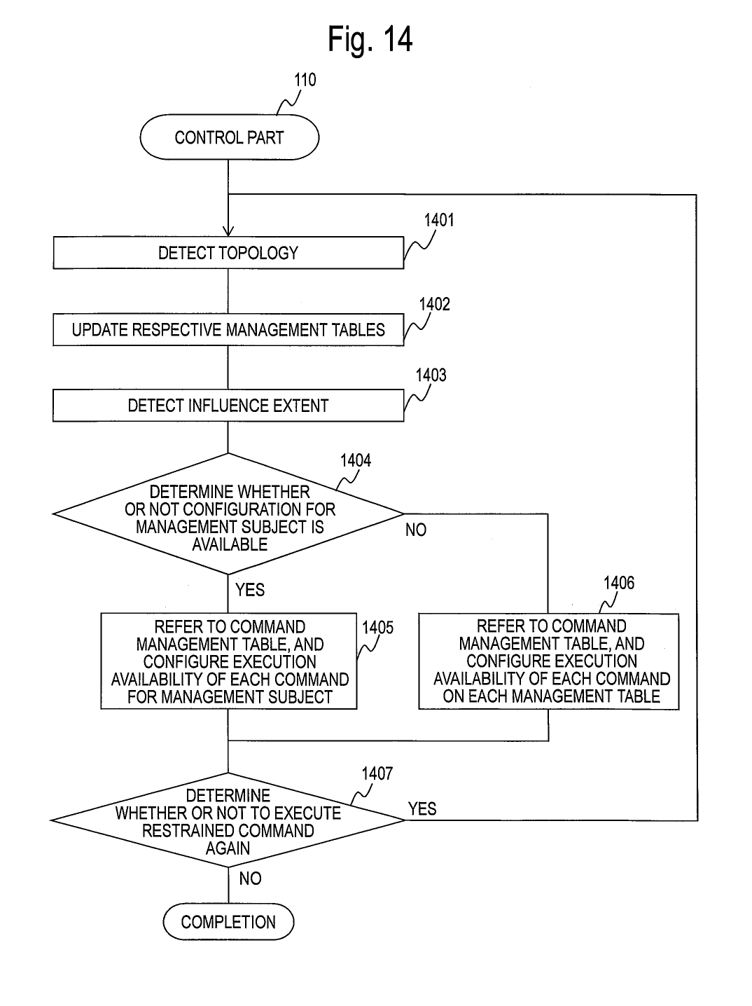

FIG. 14 is a flowchart illustrating an example of processing carried out by the control part 110 of the management server 101. The processing is carried out each time the management server 101 acquires or issues a command directed to a management subject. Regarding the acquisition of the command directed to the management subject, the management server 101 receives the command issued by the virtual server management server 151 to the first virtualization part 401, the second virtualization part 403, or the virtual server 404, and restrains the command or transfers the command to the management subject depending on the configuration of the configuration availability management table 228.

In Step 1401, the control part 110 detects a topology of the management subjects. Simultaneously, the control part 110 may detect coupling relationships to the management server 101 and the management system. Then, the control part 110 proceeds to Step 1402.

In Step 1402, the control part 110 updates the management table group 111 based on the topology acquired in Step 1401, and proceeds to Step 1403.

In Step 1403, the control part 110 invokes the influence extent detection part 211, identifies an influence extent of the command caused by the parent-child relationship such as the relationship between the upper layer and the lower layer of the management subject, identifies an operation such as the presence/absence of command restraint for each of the management subjects, and proceeds to Step 1404. The processing by the influence extent detection part 211 is described later.

In Step 1404, the control part 110 invokes the configuration availability determination part 212, determines whether or not the configuration of the restraint of the command is available for the management subject, and if the configuration is available, proceeds to Step 1405, and if the configuration is not available, proceeds to Step 1406.

In Step 1405, the control part 110 invokes the management subject configuration part 213, refers to the command management table 227, and configures the execution availability (or whether or not the command is restrained) of each command directed to the management subject (command control part) on the table group 111 such as the configuration availability management table 228 and the like.

In Step 1407, the control part 110 invokes the table configuration part 214, refers to the command management table 227, and when the command is restrained or is conditionally restrained or is conditionally executed, determines whether or not the command is executed again for another management subject in the parent-child relationship. If the command is to be executed again, the control part 110 returns to Step 1401. If the command is not executed again, the control part 110 configures the execution availability of each of the commands on each of the management tables, and finishes the processing. In this step, the control part 110 may further refer to the information on the execution availability configured on each of the management tables, and may provide a chance to select whether or not the command is displayed on a GUI provided by the management server 101.

FIG. 15 is a flowchart illustrating an example of processing carried out by the influence extent detection part 211.

In Step 1501, the influence extent detection part 211 refers to the system management table 226, refers to columns 1108 and 1109, and acquires information on the topology such as the parent-child relationship and mutual associations representing mutual coupling relationships. Then, the influence extent detection part 211 proceeds to Step 1502.

In Step 1502, the influence extent detection part 211 refers to the command management table 227, refers to the column 1202 for contents of the execution of commands, compares the contents with the command currently to be executed, and if corresponding commands exist in the column 1202, acquires the information on the operation from the column 1203. Then, the influence extent detection part 211 proceeds to Step 1503.

In Step 1503, the influence extent detection part 211 determines whether or not the display is available and whether or not the execution is available for each of the commands, and finishes the processing.

The influence extent detection part 211 identifies the influence extent of the command execution availability relating to the parent-child relationship. For example, if a child or a parent in the parent-child relationship exists in the system management table 226, the influence extent detection part 211 identifies the parent and the child as the influence extent. Then, if the command is to be executed on the child, the influence extent detection part 211 determines whether or not the parent is activated. Moreover, the system on which the management system is running should not be stopped, and the management system is thus identified as the influence extent. The influence extent detection part 211 identifies an operation of each command based on the contents of the column 1203 of the command management table 227 for the identified influence extent.

FIG. 16 is a flowchart illustrating an example of processing carried out by the configuration availability determination part 212.

In Step 1601, the configuration availability determination part 212 refers to the command management table 227, refers to the column 1202 for contents of the execution of commands, compares the contents with the command currently to be executed, and if corresponding commands exist in the column 1202, acquires the information on the operation from the column 1203. Then, the configuration availability determination part 212 proceeds to Step 1602.

In Step 1602, the configuration availability determination part 212 refers to the configuration availability management table 228, refers to the column 1301 thereby identifying the management subject, and acquires information on the configuration availability or the configuration unavailability from the column 1302 or 1303 for each of the management subjects. As a result, the configuration availability determination part 212 acquires under what conditions the execution of the current command can be configured or the restraint of the execution can be configured on the management subject on which the command is to be executed. Then, the configuration availability determination part 212 proceeds to Step 1603.

In Step 1603, the configuration availability determination part 212 determines whether or not the command can be configured on the management subject.

If the command can be configured on the management subject, the configuration availability determination part 212 proceeds to Step 1405 in FIG. 14, and otherwise, proceeds to Step 1406. Specifically, the configuration availability determination part 212 determines whether the command can be configured on the management subject, or can be configured on the lower layer.

FIG. 17 is a flowchart illustrating an example of processing carried out by the management subject configuration part 213.

In Step 1701, the management subject configuration part 213 refers to the configuration availability management table 228, and refers to the column 1301, thereby identifying the management subject. The management subject configuration part 213 acquires the information on the configuration availability or the configuration unavailability from the column 1302 or 1303. As a result, the management subject configuration part 213 acquires information on under what conditions the execution of the command can be configured or the restraint of the execution can be configured. Then, the configuration availability determination part 212 proceeds to Step 1702.

In Step 1702, the management subject configuration part 213 provides the management subject with the configuration of unavailable execution if the command cannot be executed. On the other hand, if the command can be executed, the configuration is not particularly necessary. If permission for the execution of the command on the lower layer does not exist, a policy may be independently managed on a table, and whether or not the permission is raised may be determined by referring to the policy table. The permission may be always raised without using the policy table before the command is executed, or the permission may not be changed before the command is executed.

FIG. 18 is a flowchart illustrating an example of processing carried out by the table configuration part 214.

In Step 1801, the table configuration part 214 refers to the respective management tables, and refers to the column 1301, thereby identifying the management subjects. The table configuration part 214 acquires the information on the configuration availability or the configuration unavailability from the column 1302 or 1303. As a result, the management subject configuration part 213 acquires information on under what conditions the execution of the command can be configured or the restraint of the execution can be configured.

In Step 1802, the table configuration part 214 configures the execution availability of each of the commands for each of the management subjects, and completes the processing.

The processing of FIGS. 14 to 18 is carried out when a command is executed, and the management server 101 refers to the respective management tables and determines whether or not the command can be executed.

As a result, the control of displaying (available for selection) or not displaying (unavailable for selection) the command on a graphical user interface (GUI) of the management server 101, and the determination of the execution availability of the command in response to the execution request by the management server 101 provide such effects as restraining the operation error of the system administrator and promoting the easy operation.

<Brief Overview>

As illustrated in FIG. 5, when a business task a is running or exists on a virtual server A-1-1 of the physical server A, the management server 101 permits the power supply operation for the OS 421 and the virtual server A-1-1, but restrains the power supply operation for the second virtualization part A-1, the first virtual server A-1, and the first virtualization part A.

As a result, the second virtualization part A-1 is prevented from being shut down by mistake, and business tasks b and c are thus prevented from stopping against the intension of the system administrator. The restraint on each command may be carried out by the management server 101 which issues the command.

Moreover, a timing for restraining the execution of a command is, for example, a timing when a business task is running on the virtual server 404, the second virtualization part A-1 is running, and a management system application is installed as the business task a.

Alternatively, when the first virtualization part A and the second virtualization part A-1 provide the same function (operation directed to the virtual server such as the migration), the management server 101 restrains the function of one of the virtualization parts from operating. Alternatively, the management server 101 is prevented from issuing a command (is restrains from issuing the command). For example, when the migration is being carried out on one side, the execution of the migration on the other side is restrained.

For example, when the migration is being carried out on the upper layer and the lower layer, the management server 101 restrains the power supply shutdown command directed to the upper layer, and after the migration is completed on the lower layer, permits the power supply shutdown command directed to the upper layer. As a result, after the virtualization part on the lower layer migrates first, the power supply shutdown can be carried out.

Regarding the power supply operation command directed to the upper layer by the management server 101, if the power supply state of the upper layer is in the off state, the power supply states of the lower layers are brought into the on state starting from the lowest layer, and after the change of the subject layer to the on state is confirmed, the command to turn on the upper layer is transmitted. For example, when the second virtualization part A-1 is in the off state, the management server 101 turns on the second virtualization part A-1 by means of the power supply operation command, and after confirming the activation, the management server 101 issues commands to turn on the power supply for the virtual servers A-1-1 and A-1-2, and when the virtual servers A-1-1 and A-1-2 are activated, distributes the business task application 431 for execution. In this way, by successively turning on the power supply starting from the lower layer of the virtual computer, the management subject on the target layer can be activated.

The above-mentioned examples show cases where the management server 101 restrains the command, but the restraint of the command may be realized by configuring the restraint on the first virtualization part A and the second virtualization part A-1. The first virtualization part 401 and the second virtualization part 403 receive commands for restraint of the power supply operation command or the like directed to each of the virtual servers 402 and 404 from the management server 101. Then, when the first virtualization part 401 or the second virtualization part 403 receives a command from the management server 101 or the virtual server management server 151, if the command is a command to be restrained, the first virtualization part 401 or the second virtualization part 403 restrains the execution of the command. Alternatively, the first virtualization part 401 or the second virtualization part 403 discards the command. Moreover, if the first virtualization part 401 and the second virtualization part 403 have received conditions for the restraint of the power supply operation command directed to each of the virtual servers 402 and 404 and the like from the management server 101, when the conditions have been satisfied, the first virtualization part 401 and the second virtualization part 403 restrain the command.

In this embodiment, the example where the processing of FIG. 14 is carried out when the management server 101 acquires the command is described above, but the management server 101 may carry out the processing of FIG. 14 at a predetermined cycle to update the configuration availability management table 228. In this case, any one of the configuration availability in the column 1302 and the configuration unavailability in the column 1303 is assigned to each of the commands in the command management table 227 for each of the management subjects of the management server 101. Then, when each of the management subjects receives a command, the management subject inquires of the management server 101 whether the configuration availability in the column 1302 or the configuration unavailability in the column 1303 is assigned to the received command. Each of the management subjects may be restrained from executing, or may be permitted to execute the received command depending on a result of the inquiry from the management server 101.

This invention can be applied to a virtual computer system for virtualizing computer resources of physical computers, and is particularly preferred for a management server or apparatus for a multi-stage virtual computer system.

What is claimed is:

1. A control method for a virtual computer comprising a plurality of physical computers each comprising a processor and a memory, a network for coupling the plurality of physical computers to each other, a management server for managing the plurality of physical computers, and at least one virtual computer, which is provided by a virtualizing part executed on each of the plurality of physical computers, the management server controlling the at least one virtual computer and the virtualization part,
the control method comprising:
a first step of detecting, by the management server, a relationship between the virtualization part and the virtual computer operating on the plurality of physical computers;
a second step of detecting, by the management server, an operation state of the virtual computer; and
a third step of one of restraining and permitting, by the management server, when the management server issues a command for changing a state to one of the virtualization part and the virtual computer, issuance of the command based on an operation state of the virtual computer in a coupling relationship with the virtualization part.

2. A control method for a virtual computer according to claim 1, wherein the third step comprises restraining, when the virtual computer in the coupling relationship with the virtualization part is running, the issuance of the command for changing the state to the virtualization part.

3. A control method for a virtual computer according to claim 2, wherein the third step comprises issuing, as the command for changing the state of the virtualization part, a command for shutting down a power supply.

4. A control method for a virtual computer according to claim 1, wherein the third step comprises issuing, when the operation state of the virtual computer in the coupling relationship with the virtualization part is a stop state, the command for changing the state to the virtualization part, and issuing, when execution of the command is completed, the command for changing the state to the virtual computer.

5. A control method for a virtual computer according to claim 4, wherein the third step comprises issuing an activation as the command for changing the state of one of the virtualization part and the virtual computer.

6. A control method for a virtual computer according to claim 1,
wherein the second step comprises detecting that the operation state of the virtual computer is a state where a first command is being executed, and
wherein the third step comprises restraining, when the first command is issued to the virtualization part in the coupling relationship with the virtual computer, the issuance of the first command to the virtualization part until the virtual computer completes execution of the first command.

7. A control method for a virtual computer according to claim 6, wherein the first command issued in the third step comprises a command for migration.

8. A control method for a virtual computer according to claim 1, wherein the virtualization part comprises a first virtualization part operating on the plurality of physical computers, and at least one second virtualization part operating on the first virtualization part, and the at least one virtual computer operates on the second virtualization part.

9. A virtual computer system, comprising:
a plurality of physical computers each comprising a processor and a memory;
a network for coupling the plurality of physical computers to each other;
a management part for managing the plurality of physical computers; and
at least one virtual computer, which is provided by a virtualizing part executed on each of the plurality of physical computers,
wherein the management part controls the at least one virtual computer and the virtualization part, and
wherein the management part comprises:
a topology detection part for detecting a relationship between the virtualization part operating on the plurality of physical computers and the virtual computer;
an operation state detection part for detecting an operation state of the virtual computer; and
a command control part for one of restraining and permitting, when a command for changing a state is issued to one of the virtualization part and the virtual computer, issuance of the command based on an operation state of the virtual computer in a coupling relationship with the virtualization part.

10. A virtual computer system according to claim 9, wherein the command control part restrains, when the virtual computer in the coupling relationship with the virtualization part is running, the issuance of the command for changing the state to the virtualization part.

11. A virtual computer system according to claim 10, wherein the command control part issues, as the command for changing the state of the virtualization part, a command for shutting down a power supply.

12. A virtual computer system according to claim 9, wherein the command control part issues, when the operation state of the virtual computer in the coupling relationship with the virtualization part is a stop state, the command for changing the state to the virtualization part, and issues, when execution of the command is completed, the command for changing the state to the virtual computer.

13. A virtual computer system according to claim 12, wherein the command control part issues an activation as the command for changing the state of one of the virtualization part and the virtual computer.

14. A virtual computer system according to claim 9,
wherein the operation state detection part detects that the operation state of the virtual computer is a state where a first command is being executed, and
wherein the command control part restrains, when the first command is issued to the virtualization part in the coupling relationship with the virtual computer, the issuance of the first command to the virtualization part until the virtual computer completes execution of the first command.

15. A virtual computer system according to claim 14, wherein the first command issued by the command control part comprises a command for migration.

16. A virtual computer system according to claim 9, wherein the virtualization part comprises a first virtualization part operating on the plurality of physical computers, and at least one second virtualization part operating on the first virtualization part, and the at least one virtual computer operates on the second virtualization part.
